(19) United States
(12) Patent Application Publication
(10) Pub. No.: US 2026/0073801 A1
(43) Pub. Date: Mar. 12, 2026

(54) Artificial Intelligence Powered Dynamic Comic Generation System for Personalized Learning and a Method Thereof

(71) Applicant: 2hr Learning, Inc., Austin, TX (US)

(72) Inventors: Vicky Biswas, Dehradun (IN); Syed Mujtaba Jafri, Navi Mumbai (IN); Nauman Ahmed, Karachi (PK); Omar Khairy, Cairo (EG); Geet Dasani, Uttar Pradesh (IN); Anirudh Srikanth, Bangalore (IN)

(73) Assignee: 2hr Learning, Inc., Austin, TX (US)

(21) Appl. No.: 19/177,473

(22) Filed: Apr. 11, 2025

Related U.S. Application Data
(60) Provisional application No. 63/632,992, filed on Apr. 11, 2024.

(51) Int. Cl. G09B 5/02; G06T 11/60

(52) U.S. Cl. CPC G09B 5/02; G06T 11/60

(57) ABSTRACT

A comic generation system based on user profile details, proficiency and educational standard selects a learning topic for the comic generation by accessing the user profile details and one or more curriculum graphs stored in a curriculum database. One or more learning topics are generated that are relevant to the user profile details and the one or more curriculum graphs. The user profile details include one or more user interests obtained through the interaction between the user and a chatbot and user details stored in the user profile. The one or more curriculum graphs are generated based on curriculum obtained from the one or more educational standards.

### CROSS-REFERENCE TO RELATED APPLICATION

This application claims the benefit under 35 U.S.C. § 119 (c) and 37 C.F.R. § 1.78 of U.S. Provisional Application No. 63/632,992, filed Apr. 11, 2024, which is incorporated by reference in its entirety.

### FIELD OF THE INVENTION

The present invention relates in general to the field of electronics, and more specifically to dynamically generate a personalized curriculum aligned comics based on user interests and proficiency on a real-time basis.

### BACKGROUND OF THE INVENTION

In recent years, e-learning technologies has advanced at a rapid rate. E-learning leads to constructive learning outcomes as it allows students to actively participate in learning anytime from anywhere in the world. In recent years, adaptive e-learning is widely implemented by various education institutions and online learning companies. With customized e-learning coming into play, learning resources like books, novels, etc. have become richer and more diverse.

In conventional e-learning environments, content followed a “one style fits all” approach, which means that all students are exposed to the same learning material. This type of learning does not take into account different learning styles and preferences of students.

Conventional educational resources typically employ a standardized approach, lacking the capability to adapt to individual interests and proficiency levels. Further, the use of existing educational materials, such as textbooks or novels, is static and does not evolve with the student's ongoing journey.

Moreover, infusing narratives with a sense of enchantment and individuality demands a high degree of creativity and craftsmanship. Crafting visually appealing comics that resonate with diverse audiences requires expert storytelling skills and a keen understanding of visual storytelling techniques. However, the manual effort involved in refining these narratives to perfection can be laborious and time-consuming. From brainstorming ideas to refining character designs and layouts, each step in the comic creation process demands meticulous attention to detail and artistic flair. Comics are also often referred to as a graphic novels.

Furthermore, the pursuit of creating fancy comics that captivate and inspire adds another layer of complexity to the manual efforts required in adaptive comic generation. Storytellers must continually push the boundaries of creativity, experimenting with different artistic styles, panel layouts, and narrative techniques to engage their audience effectively. Yet, such endeavors demand significant time and effort, often requiring iterative refinement to achieve the desired impact.

### BRIEF DESCRIPTION OF THE DRAWINGS

The systems and methods described herein may be better understood, and their numerous objects, features, and advantages made apparent to those skilled in the art by referencing exemplary embodiments depicted in the accompanying figures. The use of the same reference number throughout the several figures designates a like or similar element.

FIG. 1 depicts an exemplary artificial intelligence (AI) comic generation environment.

FIG. 2 depicts an exemplary artificial intelligence (AI) comic generation process for generating personalized comics aligned with user interest and curriculum.

FIG. 3 depicts an exemplary comic generation system based on user profile, user details and proficiency.

FIG. 4 depicts a working methodology of the comic generation system for dynamic comic generation.

FIG. 5 depicts a flow diagram representing creation of main components in comic generation.

FIG. 6 depicts an exemplary curriculum graph.

FIGS. 7-8 depict exemplary views of a user interface where the user can select the topic of his/her choice.

FIGS. 9-19 depict exemplary views of dynamically generated personalized comics based on user interest, proficiency and educational curriculum.

FIG. 20 depicts an exemplary network environment in which the system of FIG. 1 and the process of FIG. 2 may be practiced.

FIG. 21 depicts an exemplary computer system.

### DETAILED DESCRIPTION

A comic generation system based on user profile details, proficiency and educational standard selects a learning topic for the comic generation by accessing the user profile details and one or more curriculum graphs stored in a curriculum database. One or more learning topics are generated that are relevant to the user profile details and the one or more curriculum graphs. The user profile details include one or more user interests obtained through the interaction between the user and a chatbot and user details stored in the user profile. The one or more curriculum graphs are generated based on curriculum obtained from the one or more educational standards. The curriculum graph includes one or more nodes related to a curriculum topic. The one or more curriculum graphs are generated by collecting one or more educational standards from official sources and organizing the curriculum data into a graph database. Each topic in the one or more curriculum graph is represented as a node and prerequisite relationships between the nodes are represented as edges. The official sources of educational standards include Common Core State Standards (CCSS), NGSS (Next Generation Science Standards), AP and so on.

The user profile details that match the selected learning topic are identified by retrieving the one or more user profile details from the user profile and comparing the one or more user profile details with the selected topic. An AI tool is prompted to pick the matching one or more user profile details that best suits the learning topic. The AI tools disclosed here include machine learning algorithm and NLP (natural language processor). A comic topic identifier operatively coupled to the comic generation platform collects user profile details including one or more pre-stored personal details of the user and one or more user interests identified based on user's interaction with the chatbot and identifies one or more matching user profile details. Finally, the comic topic identifier identifies a comic topic that matches the user profile details and one or more curriculum graphs. The comic topic is selected based upon the user profile details and the one or more curriculum graphs. The user profile details include user's pre-stored personal details received upon session login and user interests identified based upon user interaction with a chatbot. The learning topics can be selected either manually based on the interaction with the chatbot or automatically based on the user interests and proficiency.

Finally, a comic generator automatically generates a comic based upon the identified one or more user profile details. A blueprint generator creates a comic blueprint which includes a story, one or more characters and one or more scenes in the comic. A panel generator creates one or more comic panels which includes a scene having a background and the one or more characters and a text generator generates dialogues for each panel. A text-to-image diffusor model combines the dialogues to the corresponding scenes to generate the final comic. The generated personalized final comic includes 10 or more pages and the comic is displayed to the user via the user interface on the comic generation platform.

In artificial intelligence (AI) powered dynamic curriculum aligned comic generation system different AI tools are used to generate the dynamic curriculum aligned comic which includes one or more Generative Pre-Trained Transformers (GPT-4) specially trained for providing short and precise content on the basis of the prompt and one or more Claude 2 specially trained for creative story-telling and comic generation. Also, a text-to-image diffusion model is used which is configured to generate the visual element of the comics, thereby creating engaging and relevant illustrations based on the text content. The text-to-image stable diffusion model is further configured to generate a cohesive panel with consistent backgrounds and consistent characters across the corresponding panels.

Thus, an artificial intelligence powered dynamic curriculum aligned comic generation system does not require any manual interventional and thus saves a lot of time for the user. Further, the artificial intelligence (AI) powered dynamic curriculum aligned comic generation system provides a personalized comic which is generated on a real-time basis based on the user's interests, which may vary from time to time and so the comic storyline and characters.

While the artificial intelligence (AI) powered dynamic curriculum aligned comic generation system presented herein makes use of specific reference to an artificial intelligence powered dynamic curriculum aligned comic generation for the students, but it is to be appreciated that the description is also equally applicable for school teachers, parents teaching their child at home, student doing self-tutoring, coaching tutors, adults learning for their carcer development, employees in corporate training, parents for parenting education, children's for craft, music and other education, elderly people for medical guidance, medical staff for guidance and so on.

The following is an illustrative description of one or more embodiments of systems and methods. In an educational context, the technological systems and methods described herein facilitate students mastering more material in much less time than conventional education processes. The technological systems and methods include unique utilization of artificial intelligence (AI) technology that is trained and guided using, for example, technical, engineered prompts, to provide personalized student interaction and to expertly utilize academic knowledge bases, academic learning applications, multi-media, and student psychology to maximize efficient learning and subject matter mastery. For example, the systems and methods assist a student to maintain focus, reduce fatigue, maintain and enjoy subject matter engagement, encouragement, subject matter instruction coupled with efficient and rigorous testing to provide an outstanding and efficient learning environment to facilitate students mastering more material in much less time than conventional education processes.

The system and method set forth herein address technical issues with generating the desired outputs described herein. Conventionally, manual processes were used to generate the desired outputs and were very tedious and time consuming. The present system and method utilize an automated system that does not merely automate a manual process or use a conventional system in a conventional way. The present system and method utilize one or more artificial intelligence (AI) engines and integrate programmatic process management to technologically guide and constrain the one or more AI engines to produce the desired outputs in a completely different way than both any manual process and different than normal use of programs and AI engines. Exemplary AI engines include systems utilizing large language models (LLM) and specialized small language models (SLM). Utilizing specially engineered guidance and control to direct an AI system to solve the problems below presents a technical problem that requires a technical solution. The system and method described below are not simply engaging a computer to carry out conventional mental processes, but rather change how computers (and AI systems, specifically) operate to achieve the generation results that were not previously possible or were substantially inefficient prior to the system and method set forth below. The AI system needs specific technical guidance, control, and constraints to achieve results that are not otherwise achievable.

Normally AI engines are provided a single user prompt requesting the AI engine, such as OpenAI's ChatGPT and its various implementations such as Anthropic's Claude Sonnet, to perform a task and produce an output. However, this conventional AI engine prompting method has a variety of technical shortcomings. Without proper guidance and constraints, an AI engine will not produce the desired output specified as produced by the system and method described herein. Instead, the AI engine will produce many unusable outputs that are unusable for a variety of reasons including so-called “hallucinations” where the AI engine presents fabricated information, duplicate outputs, too few outputs, too many outputs, outputs that do not meet desired criteria, and so on. Without special technical guidance, the AI engine cannot reliably be applied to generate desired outcomes.

A programmatic AI engine management system generates decomposed, technically engineered AI prompts to include selected and integral AI engine guidance and constraints. The technically engineered prompts are generated and guided with programmatic, automatic inputs specifically designed to unconventionally guide and constrain an AI engine to produce desired outputs, perform quality control to retain or automatically discard outputs that do not meet guidance and constraints, and make the desired outputs available for use, such as use by computer system applications. In at least one embodiment, the problem to be solved by the integrated programmatic and AI engine system and method is uniquely and unconventionally decomposed, and AI prompts are used to solve the decomposed problem. Furthermore, the programmatic inputs to the decomposed AI prompts provide guidance to meet desired output characteristics.

Determining a number of prompts, the guidance and constraints within each prompt, and data flowing from one AI engine prompt to another, in addition to testing a number of prompts for the decomposed problem, testing within each prompt, and validating a desired quality of outputs becomes an intractable combinatorial problem without technical guidance and constraint of the system and method described herein. Thus, the present system and method described implement an integration of programmatic management over decomposed prompts with engineered AI engine guidance and constraints to effect an improvement in AI, programmatic AI management, and AI integrated with programmatic management technology. The present system and method allow computer systems to include programmatic management, one or more AI engines, and one or more data sources to produce the useful outputs described below that previously could not be produced with conventionally prompted AI engines or could only be produced by humans utilizing a completely different, time consuming, and tedious process. The system and method improve conventional methods through the use of a programmatic AI engine management system to generate decomposed, technically engineered AI prompts to include selected and integral AI engine guidance and constraints. It is, for example, the incorporation of the programmatic AI engine management system to generate decomposed, technically engineered AI prompts to include generated, integral, and unconventional AI engine guidance and constraints and execution by the one or more AI engines to provide useful results that improve existing technical processes, which is not an automation of a conventional process.

Programmatic components and AI engines generally utilize one or more processors that have access to memory, which may include one or more storage components, to execute and perform functions. An AI engine is a core hardware and software system that enables artificial intelligence applications to process data, learn patterns, and generate insights or actions. It functions as the brain behind AI-driven systems, facilitating tasks such as machine learning, natural language processing, and decision-making. Exemplary components of an AI engine are:
1. Machine Learning Models—Algorithms that analyze data, recognize patterns, and make predictions.
2. Neural Networks—Deep learning architectures that mimic the human brain for tasks like image and speech recognition.
3. Data Processing Module—Handles raw data input, transformation, and feature extraction.
4. Inference Engine—Applies trained models to make real-time decisions based on new data.
5. Optimization Algorithms—Improves model efficiency, reducing errors and improving predictions.
6. Natural Language Processing (NLP) Module—Enables AI engines to understand, interpret, and generate human language (e.g., chatbots, voice assistants).
7. Computer Vision Module—Allows AI to interpret and analyze images or videos.
8. Reinforcement Learning Mechanism—Helps AI learn from trial and error, optimizing performance over time.
9. API Interface—Connects the AI engine with applications, enabling integration with other software or platforms.

Examples of AI Engines include: Google TensorFlow, Meta's PyTorch, Microsoft Azure AI, OpenAI's GPT, IBM Watson, OpenAI Whisper, Google BERT & T5, Amazon Lex, Anthropic Claude, DeepMind's AlphaCode, Google Vision AI, Meta's DINO & SAM (Segment Anything Model), NVIDIA DeepStream. OpenCV AI Kit, Amazon Polly. Google WaveNet, Deepgram.

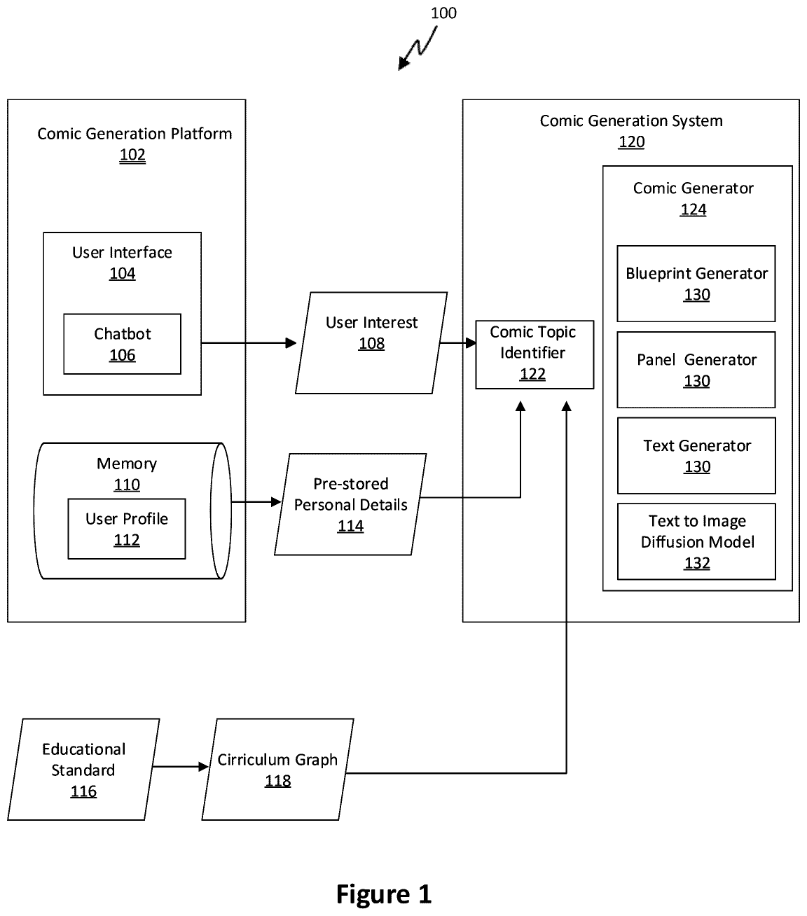

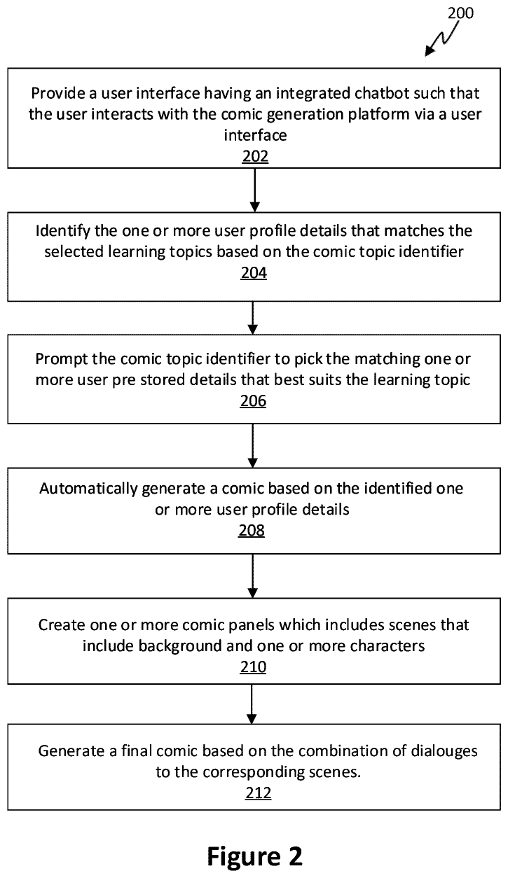

FIG. 1 depicts a comic generation environment 100 to generate one or more comics. FIG. 2 depicts a comic generation process 200 utilized by the comic generation environment 100.

Referring to FIGS. 1 and 2, in operation 202, the comic generation platform 102 provides a user interface 104 having an integrated chatbot 106 such that a user interacts with the comic generation platform 102 via the user interface 104. The user may log into the comic generation platform 102 using any suitable computing device including mobile, computer, tablet, laptop, and so on. The user accesses and interacts with the comic generation platform 102 via user interface 104 having an integrated chatbot 106. The user profile details and one or more curriculum graphs 118 stored in a curriculum database obtained from the one or more educational standards 116. The chatbot 106 is operatively coupled to the comic generation platform 102 and allows users to access the comic generation platform 102 and provide their inputs and receive a response whenever required. The user interface 104 plays a vital role in facilitating user interaction with the comic generation platform 102. It serves as a bridge between the comic generation platform 102 and comic generation system 120, providing a user-friendly environment for the comic generation. The user interface 104 is designed to be intuitive, visually accessible, and conducive to a seamless user experience. The user interface 104 is thoughtfully designed to be visually appealing and easy to navigate, ensuring that users can effortlessly input their preferences. The user interface 104 is operatively coupled to the comic topic identifier 122 and comic generator 124 of the comic generation system 120, which are discussed in the latter section.

The comic topic identifier 122 identifies one or more learning topics that are relevant to the user profile details and the one or more curriculum graphs 118. The user profile details include the one or more user interests 108 obtained through the interaction between the user and the chatbot 106 and the user pre-stored personal details 114 obtained through the user profile 112. The user pre-stored personal details 114 is stored in the memory 110 of the comic generation platform 102. The one or more curriculum graphs 118 are generated based on curriculum of one or more educational standards 116. The curriculum graph 118 includes one or more nodes related to a curriculum topic. The one or more curriculum graphs 118 are generated by collecting one or more educational standards 116 from one or more official sources and organizing the curriculum data into a graph database. Each topic in the one or more curriculum graph 118 is represented as a node and prerequisite relationships between the nodes are represented as edges. The official sources include Common Core State Standards (CCSS), NGSS (Next Generation Science Standards), AP and so on. The comic generation environment 100 includes a curriculum graph 118, which includes a graph that focuses on mastery-based learning. The curriculum graph 118 contains dependencies and connections between one or more educational standards 116, which allows target content retrieval and alignment with related educational material for comprehensive learning outcomes.

The one or more curriculum graphs 118 are generated based on the curriculum of one or more educational standards 116. Each curriculum graph 118 includes one or more nodes related to a curriculum topic. This helps in visualizing the learning pathway in an organized manner. These relationships indicate the learning sequence, as determined from the connections explicitly stated within the educational standards 116. The comic generation environment 100 can handle multiple prerequisites for a single topic, creating a complex curriculum graph 118 that visualizes the learning pathway for each topic for complete understanding.

In operation 204, the comic topic identifier 122 identifies the one or more user profile details that match the selected learning topic by retrieving the one or more user pre-stored personal details 114 from the user profile 112 and the machine learning algorithm of the comic topic identifier 122 compares the one or more user profile details with the selected topic. The learning topics are selected either by manually inputting the learning topic while the user is interacting using a chatbot 106 or automatically selecting the learning topic based upon one or more pre-stored personal details of the user and one or more user interests 108 identified based on the user's interaction with a chatbot 106 using a machine learning algorithm. The one or more pre-stored personal details 114 of the user stored within a memory 110 of the comic generator platform 102. The user profile 112 includes the user pre-stored personal details 114 received upon session login and user interests 108 identified based upon user interaction with a chatbot 106.

The comic topic identifier 122 retrieves the one or more user pre-stored personal details 114 stored in a memory 110 of the comic generation platform 102 and compares the one or more user pre-stored personal details 114 to the selected topic. Here, the user pre-stored personal details 114 are retrieved from the user profile 112 and one or more user interests 108 through chatbot 106 interaction. The user pre-stored personal details 114 includes data related to the user's personal details like name, age, class, friend's details, family details, hobbies and so on. The user profile 112 is created once the user logs in the comic generation platform 102 and starts the session. The user profile 112 keeps on updating on a real-time basis on the basis of the input provided by the user on the chatbot 106.

In operation 206, the comic topic identifier 122 is prompted to pick the matching one or more user pre-stored personal details 114 that best suits the learning topic. The AI tools disclosed here include machine learning algorithm and NLP (natural language processor). A comic topic identifier 122 operatively coupled to the comic generation platform 102 collects user profile details including one or more pre-stored personal details of the user 114 and one or more user interests 108 identified based on user interaction with the chatbot 106 and identifies one or more matching learning topics of interests. Finally, the comic topic identifier 122 identifies a comic topic that matches the user profile details and one or more curriculum graphs 118. The comic topic is selected based upon the user profile details and the one or more curriculum graphs 118. The user profile details include user pre-stored personal details 114 received upon session login and one or more user interests 108 identified based upon user interaction with a chatbot 106. The learning topics can be selected either manually based on the interaction with the chatbot 106 or automatically based on the user profile details and proficiency.

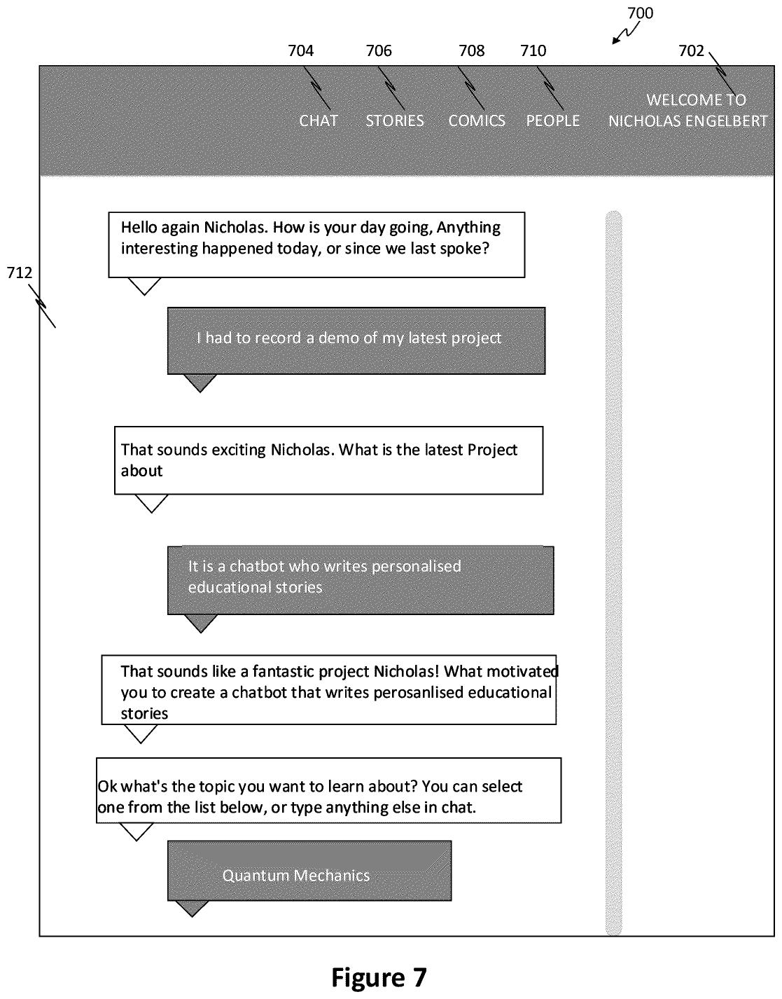

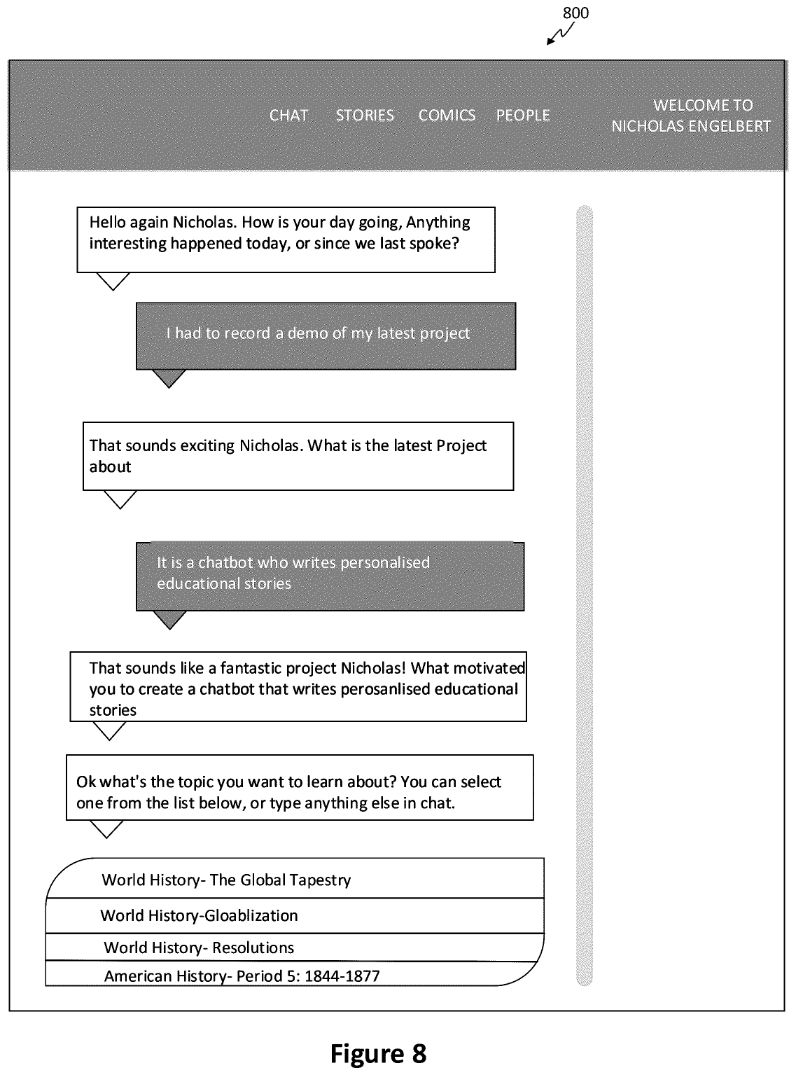

The user can interact with chatbot 106, an example of this is shown in detail in FIGS. 7 and 8. Using the chatbot 106 interactions, the one or more user interests 108 like his/her daily events, places visited and so on can be obtained. The retrieved data is stored in memory 110 operatively coupled to the comic generation interface 102 and processed in the comic topic identifier 122.

In an exemplary embodiment, the student's profile is encapsulated within a data structure, where each key-value pair signifies a distinct attribute of the student, encompassing learning level and interests. Interests are articulated as a type and a value. This student profile serves as a critical component in the personalization of the comic content. The below pseudo code represents exemplary data structure of “student profile”:

```
      student_profile = {
    “student_id”: “string”,
    “reading_level”: “string”,
  “grade”: “string”,
  “personality”: “string”,
  “interests”: [
        {“type”: “string”, “value”: “string”},
        {“type”: “string”, “value”: “string”},
    ],
  ”incidents”: [
        {“date”: “datetime”, “description”: “string”},
        {“date”: “datetime”, “description”: “string”},
    ]
}
```

The user profile details obtained are then compared with selected topics to pick up the top three topics of interest. The artificial intelligence tool is prompted to pick up the best interest from the top three interests that best suits the learning topic for the comic. This would be clear from the following example, suppose a student named Alex has inputted while chatting with chatbot 106 that he went to a museum, rock concert and a beach vacation. He wished to learn about the process of photosynthesis using the comics. The comic topic identifier 122 will check his topics of interest and match the interests with the curriculum graph 118 that covers the topic photosynthesis. The comic topic generator 122 will check that beach vacation is the most relevant topic of interest out of three and comic generator 124 will generate a personalized comic for Alex to help him learn the concepts of photosynthesis according to his grade and proficiency level.

In operation 208, finally a comic generator 124 automatically generates a comic based upon the identified one or more user profile details. A blueprint generator 126 creates a comic blueprint which includes a story, one or more characters and one or more scenes in the comic. The blueprint of the comic is divided into various acts or scenes. The blueprint generator 126 uses an artificial intelligence tool to generate the blueprint of the comic which includes a natural language processor (NLP) and a machine learning model like ChatGPT 4 from OpenAI and so on.

The comic blueprint is structured as a data structure. The data structure encapsulates the basic story, characters, scenes, and stages of the comic. Each character and scene are represented as a scene with relevant details. Each stage is further divided into panels, represented as a list of scenes, each containing information about the acts, characters, dialogues, and image description.

The below pseudo code represents exemplary data structure of “generation of blueprint”:

```
    comic_blueprint = {
  “basic_story”: “string”,
  “characters”: {
      “character1”: {
        “visual_description”: “string”,
        “personality”: “string”
      },
      “character2”: {
        “visual_description”: “string”,
        “personality”: “string”
      }
  },
  “scenes”: {
      “scene1”: “string”,
      “scene2”: “string”
  },
  “stages”: {
      “Stage 1”: {
        “story”: “string”,
        “panels”: [
          {
            “scene”: “string”,
            “characters”: [“string”],
            “narration”: “string”,
            “dialogues”: [“string”],
            “image_description”: “string”
          }
        ]
      },
      “Stage 2”: {
        “story”: “string”,
        “panels”: [
          {
            “scene”: “string”,
            “characters”: [“string”],
            “narration”: “string”,
            “dialogues”: [“string”],
            “image_description”: “string”
          }
        ]
      }
  }
}
```

The comic generation system 120 used to generate dynamic curriculum aligned comic includes, but is not limited to, one or more Generative Pre-Trained Transformers (GPT-4) specially trained for providing short and precise content on the basis of the prompt and one or more Claude 2 specially trained for creative story-telling and comic generation.

In operation 210, a panel generator 128 operatively coupled to the comic generator 124 creates one or more comic panels which includes a scene having a background and the one or more characters and a text generator 130 generates dialogues for each panel. Each comic panel is produced using an act or scene by organizing these acts in a structured format. The comic panels include the details of the scenes of the comics like the background details of the comics. For example, if the students are taught science lessons of plantation by giving an example of a comic character Dora playing in a park. Then the panel background will be park in all images. The dialogues are created after creating the images for the panel using text generator 130.

In operation 212, a text-to-image diffusor model 132 combines the dialogues to the corresponding scenes to generate the final comic. The text-to-image diffusion model 132 is further configured to generate the visual element of the comics, thereby creating engaging and relevant illustrations based on the text content. Further, a text-to-image diffusor model 132 is used to create visual descriptions and conversations for each panel. The text-to-image diffusor model 132 is operatively coupled to the comic generator 124 to generate a cohesive panel with consistent backgrounds and consistent characters across the corresponding panels.

The text-to-image diffusor model 132 combines dialogues to the corresponding scenes to form a comic by imposing the content on the comic images. The comic is formed by imposing and stitching together dialogues and narratives in the form of text bubbles. The examples of text-to-image diffusor model 132 may include Midjourney, SDXL and so on. Although not limited to, there could be other text-to-image diffusor model 132 as well that can be used for the conversion of text to image i.e., to convert the prompt given to the AI tool in the form text as an image. For this purpose, the image prompts, the description of the characters and scenes are generated by incorporating the overall story context. The description is used along with the GPT prompt to create detailed descriptions for each panel's image, maintaining consistency in characters and scenes. The unique structure of prompt utilization allowed us to generate a comprehensive and coherent comic narrative automatically.

Finally, the generated personalized final comic includes 10 or more pages and the comic is displayed to the user via the user interface 104 operatively coupled to the comic generation platform 102. The generated comic is made using comic generator 124 like the natural language process (NLP), machine learning and so on based on the user pre-stored personal details 114, one or more user interests 108, user's proficiency level and one or more curriculum graph 118 obtained from the one or more educational standards116.

In an embodiment, the chatbot 106 and memory 110 is operatively coupled to the comic generation platform 102. The comic generation platform 102 comprises a user interface 104 and a memory 110 which further includes chatbot 106 and user profile 112 respectively. The one or more user interests 108 are obtained through interaction between user and the chatbot 106 and user pre-stored personal details 114 is obtained using user profile 112.

The comic generation system 120 is operatively coupled to the comic generation platform 102. The comic generation system 120 includes comic topic identifier 122 and comic generator 124. The one or more user interests 108, user pre-stored personal details 114, curriculum graph 118 is stored and processed in comic topic identifier 122 to identify a learning topic that best matches the user profile details and curriculum graph 118. The comic topic identifier 122 uses machine learning algorithms to identify the learning topic.

In one embodiment, the comic generation environment 100 includes a comic topic identifier and comic generator 124, operatively coupled to the comic generation platform 102. The memory 110 stores comic content and also includes codes which when executed causes the one or more processors to generate a dynamic curriculum aligned comic based on one or more educational standards 106, user's interests and proficiency.

The below pseudo code represents exemplary structured data for “comic generation environment” 100:

```
  import large_language_model as llm
  import image_generation_model as igm
  import comic_assembler as ca
  import student_profile as sp
  # Function to select the best interest to teach the topic
  def select_interest(student_id, topic):
    # Retrieve student's interests from the profile
    # These will be books, series, movies, happenings in day to
day life etc.
    student_profile = sp.get_student_profile(student_id)
    interests = student_profile[“interests”]
    # Determine the best interest to teach the topic
    selected_interest = llm.select_interest(topic, interests)
    return selected_interest
  # Function to generate the comic blueprint
  def generate_blueprint(topic, selected_interest, learning_level):
    # Generate the comic blueprint
    comic_blueprint = llm.generate_comic_blueprint(topic,
selected_interest, learning_level)
    return comic_blueprint
  # Function to generate details of each act and panel
  def generate_act_and_panel_details(comic_blueprint):
    # Generate details of each act
    acts = [ ]
    for act in comic_blueprint[“acts”]:
      # Generate act details
      act_details = llm.generate_act_details(act)
      # For each act, generate panel details
      panels = [ ]
      for panel in act_details[“panels”]:
        panel_details = llm.generate_panel_details(panel)
        panels.append(panel_details)
      act_details[“panels”] = panels
      acts.append(act_details)
    return acts
  # Function to generate images for each panel
  def generate_images(acts_details):
    images = [ ]
    for act in acts_details:
      for panel in act[“panels”]:
        # Generate image for each panel
        image = igm.generate_image(panel[“image_prompt”])
        panel[“image”] = image
        images.append(panel)
    return images
  # Function to assemble the comic
  def assemble_comic(acts_details):
    # Assemble the comic from acts and their panels
    comic = ca.assemble_comic(acts_details)
    return comic
  # Function to dynamically generate curriculum-aligned comic
  def generate_comic(student_id, topic):
    # Retrieve student's learning level
    student_profile = sp.get_student_profile(student_id)
    learning_level = student_profile[“learning_level”]
    # Select the best interest to teach the topic
    selected_interest = select_interest(student_id, topic)
    # Generate the comic blueprint
    comic_blueprint = generate_blueprint(topic,
selected_interest, learning_level)
    # Generate details of each act and panel
    acts_details =
generate_act_and_panel_details(comic_blueprint)
    # Generate image for each panel
    panel_images = generate_images(acts_details)
    # Assemble the comic
    comic = assemble_comic(acts_details)
    return comic
```

The provided pseudo-code represents the key functions of the comic generation environment 100. These pseudo functions include selecting an interest to align with the teaching topic, creating a comic blueprint, generating detailed descriptions for each stage, formulating comic panel details, producing images for each panel, and finally, assembling the comic.

The function ‘select_interest’ retrieves the user pre-stored personal details 114, which includes their learning level and interests such as hobbies, fictional interests, and events like Christmas, attending concerts, visiting museums and so on. The artificial intelligence tools like LLM (large language model) then determine the most suitable interest to use to teach the topic, based on its relevance and the student's preference.

The selected interest is then incorporated in the ‘generate_blueprint’ function. The blueprint generator 126 uses the artificial intelligence tool like natural language processing and machine learning model like ChatGPT 4 etc., to create a comic blueprint that not only aligns with the topic and the student's learning level, but also integrates the selected interest to make the learning experience more engaging and personalized.

The panel generator 128 and text generator 130 incorporates ‘generate_act_and_panel_details’ that uses artificial intelligence tools like Claude 2, Midjourney, SDXL and so on to generate detailed descriptions for each act and panel based on the blueprint. The ‘generate_images’ function then uses an image generation model to create images for each panel based on these descriptions. Further, the dialogues are generated for each panel.

Finally, the text-to-image diffusion model 132 incorporates the ‘assemble_comic’ function and compiles all the generated elements to create the final comic. This comprehensive process ensures the creation of a curriculum-aligned, personalized, and engaging comic for the student.

The comic generation environment 100 uses comic generator 124 which includes multiple AI tools like blueprint generator 126, panel generator 128, text generator 130 and text-to-image generator 132 because of their unique strengths. For instance, Claude-2 from Anthropic is used because of its large context window and creative storytelling, to plan the entire story into several acts. Further, the GPT-4 from OpenAI, an LLM with superior instruction-following skills, to refine each act's story into dialogues and narrations, ensuring character consistency in each dialogue is employed to the comic generation platform 102.

For image prompts, the description of the characters and scenes are generated by incorporating the overall story context. The description is used along with the GPT prompt to create detailed descriptions for each panel's image, maintaining consistency in characters and scenes. The unique structure of prompt utilization allowed us to generate a comprehensive and coherent comic narrative automatically.

The comic generation environment 100 can provide multiple results on the same topic with different characters, for example, if a student of Grade 3 is interested in learning about the process of digestion. Then an AI engine that includes, for example, a natural language processor and machine learning model, collects the student interest from the student profile and chatbot with which the student interacts. For example, suppose the student wants to learn the process of digestion through different cartoon characters like Doraemon, Pokemon etc. Then the comic generation system 120 will generate two different comics based on these cartoon characters whose primary focus is to teach students about the digestion process which falls under the curriculum of Grade 3. Although the intent of both these comics would be the same, the content would be different.

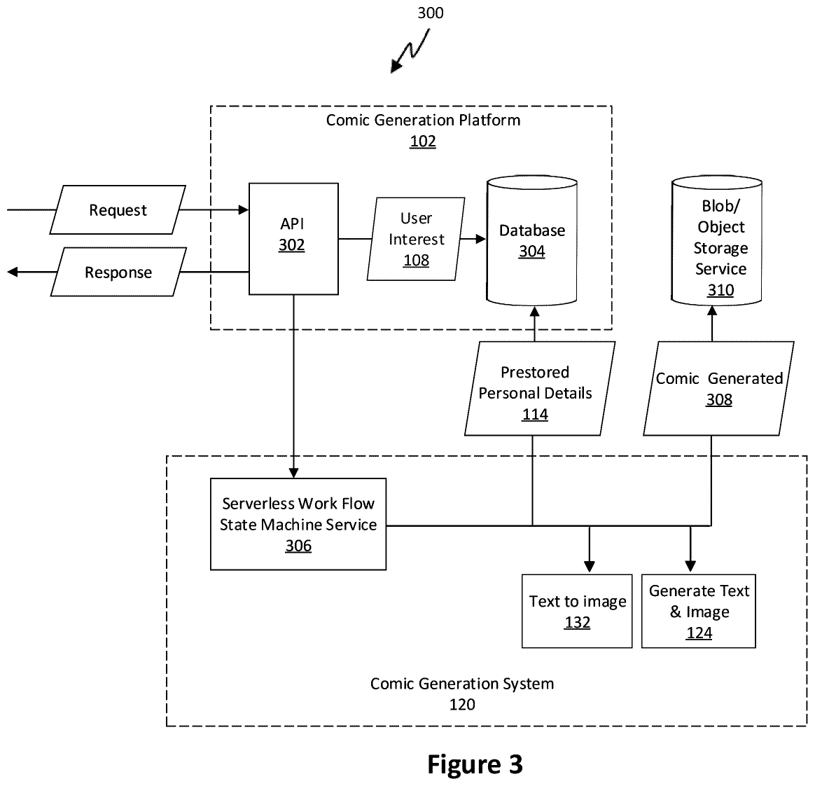

FIG. 3 depicts an exemplary comic generation system 300 based on user profile, user details and proficiency. The exemplary comic generation system 300 based on pre-stored personal details 114 and proficiency disclosed herein includes an API (application programming interface) 302, database 304, serverless workflow state machine service 306, text-to-image diffusion model 132, text and image generator 124 and blob/object storage service 308. The API 302, database 304 are operatively coupled to form comic generation platform 102 and serverless workflow state machine service 306, text-to-image diffusion model 132, text and image generator 124 are operatively coupled to form comic generation platform 120. Further, the student's pre-stored personal details 114 and one or more student's interests 108 are obtained from the student's profile 112 stored in the memory 110 of the serverless workflow state machine service 306 and API respectively.

The comic generation platform 102 is operatively coupled to the chatbot 106 and is the main user interface 104 through which users interact. The chatbot 106 facilitates communication between the user and the comic generation platform 102. Users can provide input, such as preferences or details, which a comic generation system 120 will use to generate a personalized comic.

The API 302 serves as the interface through which users interact with the comic generation platform 102. The API 302 defines the protocols and tools that enable communication between the user and the comic generation system 120. Users can submit requests, such as providing input for comic generation or retrieving generated comics, through the API 302. The API 302 also handles authentication, security, and data validation to ensure smooth and secure communication between the user and the comic generation system 120.

The database 304 is responsible for storing and managing data related to the comic generation process. It stores various types of information, including user profiles, comic templates, generated comics, and any other relevant data needed for comic generation. The database 304 ensures data integrity, reliability, and accessibility, allowing the comic generation system 120 to retrieve and update information efficiently during comic generation.

The serverless workflow state machine service 306 serves as the heart of the comic generation platform 102 and comic generation system 120 and coordinates the flow of operations involved in comic generation. It orchestrates different tasks and services required for comic creation, ensuring that they are executed in the correct sequence and with proper dependencies. The serverless workflow state machine service 306 architecture enables scalability and cost-effectiveness by automatically scaling resources based on demand, without the need for managing servers manually.

The text-to-image diffusion model 132 is a machine learning model trained to generate visual representations of textual content by taking textual dialogues and descriptions as input and producing corresponding images or scenes that match the provided text. The text-to-image diffusion model 132 is crucial for converting dialogue scripts into visually appealing comic panels, enriching the storytelling experience. The text-to-image generator 124 is responsible for generating textual and visual elements of the comics, such as characters, backgrounds, and props by utilizing the predefined templates, algorithms, or machine learning models to create these elements based on the requirements specified in the comic blueprint. The text-to-image generator 124 works in tandem with other components to populate comic panels with appropriate characters, scenes, and visual details.

The blob/object storage service 308 provides scalable and durable storage for various assets used in comic generation, such as images, text files, and generated comics.

Furthermore, the comic generation system 300 uses the user's pre-stored personal details 114 and interests to tailor the comic generation process. The details are retrieved from the student's profile 112, which is stored in the memory 110 of both the serverless workflow state machine service 306 and the API 302. By utilizing the user's pre-stored personal details 114, the comic generation system 300 can create comics that resonate with the user's preferences and interests and thereby enhancing the overall user experience.

The disclosed comic generation system 300 is a comprehensive platform that seamlessly integrates various components to produce personalized comics based on user profile details and interests. The innovative approach to comic creation offers users a unique and engaging experience in exploring the world of comics.

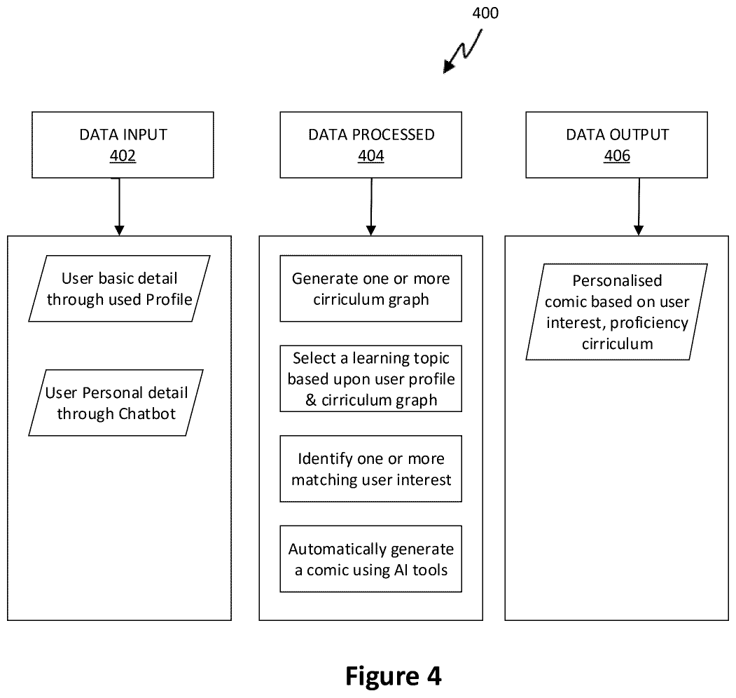

FIG. 4 depicts the working methodology 400 of the comic generator system 120 for dynamic curriculum aligned comic generation. The data input 402 i.e., the user profile details which includes the one or more user interests 108 obtained through the interaction between the user and the chatbot 106 and the one or more user pre-stored personal details 114 obtained through user profile 112 and is stored in the memory 110. The comic topic identifier 122 stores the data input 402 and the curriculum graph 118 obtained from the one or more educational standards 116. The comic topic identifier 122 further processes the data input 402 and the curriculum graph 118 to identify the one or more topic of interest that best suits the learning topic for the user. The data input 402 keeps on updating on a real time basis. The data processed 404 includes the steps using which the personalized comic is generated using the comic topic identifier 122 and comic generator 124. The data output 406 i.e., the final personalized comic which is generated using comic generator 124 based on the user interests 108, user pre-stored personal details 114, user proficiency and educational standards 116.

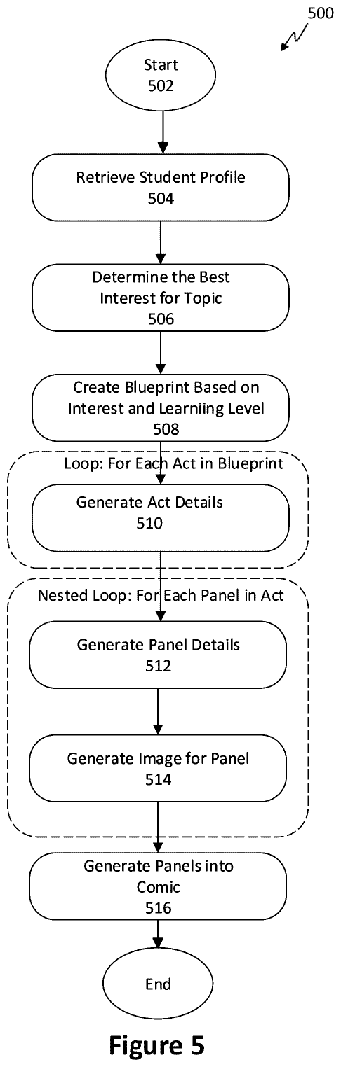

FIG. 5 depicts the flow diagram 500 representing story generation. In flow diagram 500, the process 200 for comic generation starts 502 when the user i.e., student in this exemplary scenario starts the session by logging in the comic generation platform 102 from his/her device.

The student's pre-stored personal details 114 like student's interests and student's personal details are retrieved 504 from the student profile 112. Also, the one or more student's interests 108 is obtained through the interaction between the user and the chatbot 106, which is operatively coupled to the comic generation platform 102. The educational standards 116 are collected from various official sources and a curriculum graph 118 is generated based on the curriculum of one or more educational standards 116. A comic topic identifier 122 operatively coupled to the comic generation platform 102 identifies the best learning topic for the comic 506 that matches the student profile details 504 and the one or more curriculum graph.

The comic topic identifier 122 retrieves the one or more user pre-stored personal details 114 stored in a memory 110 of the comic generation platform 102 and one or more user interests 108 through the interaction between the user and the chatbot 106 and compares it with the selected topic. An AI tool is prompted to pick one or more matching profile details 504 that best suits the selected comic topic. The comic generator 124 generates a personalized comic by utilizing the matching profile details 504. Out of these three topics, the best topic is chosen 506 on the basis of student's interest and proficiency level.

A blueprint generator 126 is operatively coupled to the comic generator 124 to create comic blueprint 508 which includes a story, one or more characters and one or more scenes in the comic. A comic blueprint is generated 508 based on the student's interest 108, student's pre-stored personal details 114 and learning level. In the next step 510, a loop is created in which the generated comic blueprint from step 508 is divided into number of acts or scene 510. For example, the comic blueprint has different acts like ‘hero enters’, ‘hero faces some problems’, ‘hero leaves’ and so on. These are the acts or scenes based on which the comic blueprint is divided. The panel generator 128 operatively coupled to the comic generator 124 creates one or more comic panels which includes a scene having a background and the one or more characters.

Further in step 512, the panel generator 128 operatively coupled to the comic generator 124 creates one or more comic panels in a nested loop format which are part of an act or scene. Each panel represents the storyline of the act and images and texts in bubbles are placed in each panel. For example, if a student visits a concert and is interested in learning music related topics, then he may get the background of the concert or something of this type as this is his area of interest. On the basis of the best topic chosen in step 506, comic blueprint generated in step 508 and panel details generated in step 512, a text generator 130 generates the text for the corresponding scenes of the panel that are generated in step 514. The text-to-image diffusion model 132 compiles all the dialogues of the corresponding scenes to generate a personalized comic 516.

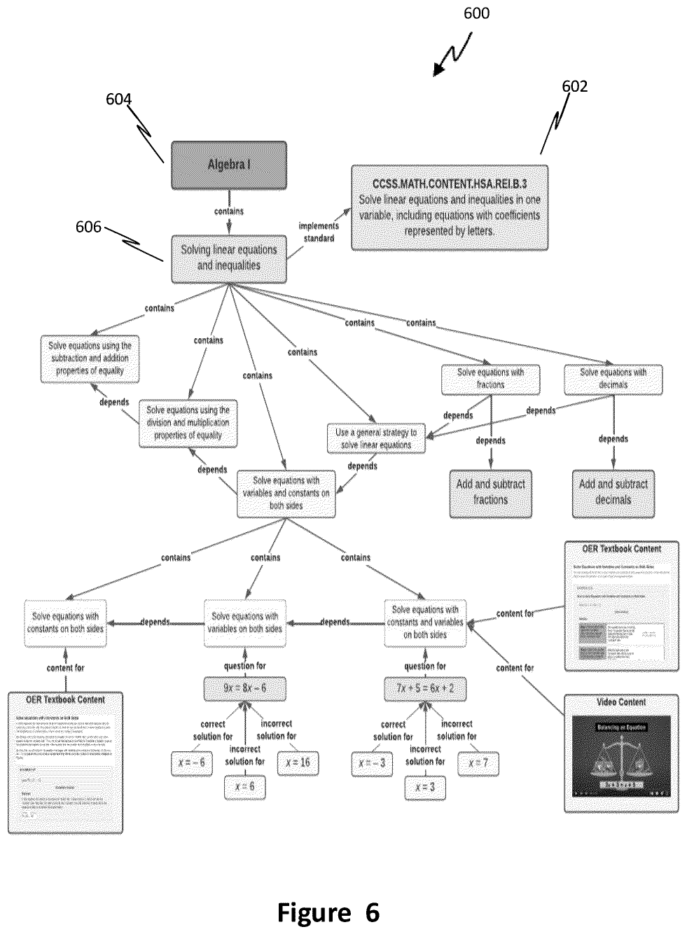

FIG. 6 depicts a curriculum graph 600. The comic generation environment 100 creates a curriculum graph 118 by collecting educational standards 116 from official sources like Common Core, NGSS, AP and so on. Each topic in the educational standard 116 is stored as nodes in a graph database, with edges representing prerequisite or dependency relationships to those topics. These relationships indicate the learning sequence, as determined from the connections explicitly stated within the standards. The comic generation environment 100 can handle multiple prerequisites for a single topic, creating a complex graph that visualizes the learning pathway for each topic for complete understanding.

The exemplary curriculum graph 600 shown in FIG. 6 discloses a curriculum graph 600 made from the educational standard CCSS (Common Code State Standard) where 602 represents the code for the particular educational standard i.e., ‘solve linear equations and inequalities in one variable, including equations with coefficients represented by letters. The curriculum graph 600 belongs to the ‘Algebra’ 604 category of mathematics.

The topic disclosed here is ‘Algebra’ 604 under which various nodes are defined like in this case based on the CCSS 602, the node 606 will be ‘solving linear equations and inequalities. Similarly, there are different methodologies and techniques to solve these equations, which are a part of the educational curriculum as well. So, these methodologies are defined as the nodes of the next level.

The curriculum topics are encapsulated within a graph data structure, functioning as a graph database. Each node signifies a topic, and the edges outline the relationships between the two, including progression and prerequisites. The curriculum graph 118 supports multiple educational standards 116, and houses comprehensive details of each topic included in their curriculums. The structure's design facilitates easy traversal and identification of related topics, proving instrumental in generating personalized content.

FIG. 7-8 depicts an exemplary view of a user interface 104 from the user can select the topic of his/her choice. The user interface 104 which is accessed by the user using a comic generation platform 102 is operatively coupled to the comic topic identifier 122 in order to select the topic of his/her choice.

In chatbot 700 and 800, the tabs 702 represents user id, which is ‘Nicholas Engelbert’ in this example. On clicking the tab 704, the user 102 can access the chats done with the chatbot. Further, on clicking the tab 706, 708 and 710, the user can access stories, comics and his profile 112 respectively. The section 712 discloses the chat between the chatbot 700, 800 and the user. Based on the discussion between the user and the chatbot 700, 800, the topic for comic generation is finalized.

In chatbot 700, the user enters the topic of his choice manually i.e., ‘quantum mechanics’. However, in chatbot 800, the user selects the topics of his choice from the four options provided to him based on his educational curriculum 116.

The chatbot 700, 800 allows users to select either the topic of his/her choice by manually entering the topic of interest or may select any one topic from the multiple options provided by the chatbot itself.

The comic topic identifier 122 is operatively coupled to the comic generation platform 134 which collects user pre-stored personal details 114 including one or more pre-stored personal details of the user and one or more user interests 108 identified based on user's interaction with the chatbot 106. Based on this the identified comic topic is matched with the user pre-stored personal details 114 and one or more curriculum graphs 118. The comic topic identifier 122 is further configured to retrieve the one or more user profile details stored in the memory 110 of the comic generation platform 102. The one or more user profile details includes the user pre-stored personal details 114 obtained from user profile 112 and one or more user interests 108 obtained from interaction between the user and the chatbot 106. The one or more user profile details are compared to the selected topic and based on this the AI tool is prompted to pick one or more matching profile details that best suits the selected comic topic. The comic generator 124 generates a personalized comic by utilizing the matching user profile details.

Following is an exemplary prompt and exemplary textual output:
Create a graphic novel designed for a 4th grade student that aligns with the Common Core ELA Standard RL.4.3: Describe in depth a character, setting, or event in a story, drawing on specific details in the text.
Customization based on student interests:
The student enjoys superheroes, especially characters like Superman, Wonder Woman, and other courageous, justice-driven heroes. Incorporate either well-known, school-appropriate superhero figures or create original heroes with similar attributes (e.g., strength, flight, leadership, compassion). The heroes should serve as positive role models and help convey the story's message in an engaging way.
Story Requirements:
   The narrative must have a clear beginning, middle, and end.
   Include a central conflict that is resolved by the end of the story.
   Develop the main character(s) in depth, showing their thoughts, feelings, actions, and motivations.
   Make sure the setting is described in detail, appropriate to the superhero genre (e.g., city under threat, secret lair, school environment).
   Vocabulary and dialogue must match a 4th-grade reading level.
   Avoid all inappropriate content: no politics, profanity, sexual content, excessive violence, or mature themes.
Visual and Descriptive Elements:
   Describe each scene clearly to allow an illustrator to visualize it panel by panel.
   Include expressive dialogue, action, and character emotions.
   Use suspense, humor, and positive conflict resolution to keep readers engaged.
Quality Control Checklist (ChatGPT must follow this):
   Aligned with RL.4.3 (deep character, setting, or event description)
   Characters/themes reflect the student's interest in superheroes
   No political, profane, or inappropriate content
   Positive values demonstrated by characters (e.g., courage, fairness, teamwork)
   Clear plot arc and character development
   Age-appropriate language and content
   Educational value clearly supported
At the end, provide a short explanation (2-3 sentences) of how the story aligns with the educational standard RL.4.3.

Following is an exemplary output of the foregoing prompt that utilizes fictional superhero characters. Other archetype characters can be used depending on, for example, an interest expressed in the student's profile, such as actual historical figures or other well-known or imaginary characters with, for example, characteristics specified by the student profile:

```
  Here's a graphic novel designed for a 4th-grade student, aligned with
**CCSS.ELA-LITERACY.RL.4.3**, tailored to their interest in superheroes like
Superman and Wonder Woman, and meeting all specified requirements.
  ---
  ### Graphic Novel Title: *The Sky Guardians and the Lost Light*
  #### Overview:
  This 12-page graphic novel follows two original superheroes, Captain Blaze (a
boy with flight and fire powers) and Luna Star (a girl with super strength and glowing
energy), as they protect their city, Brightvale, from a mysterious shadow that dims the
sun. The story emphasizes courage, teamwork, and compassion, with a focus on Captain
Blaze's development as he overcomes self-doubt to save the day.
  ---
  ### Page-by-Page Breakdown:
  #### Page 1: The Beginning - A City in Trouble
  **Scene:** A wide shot of Brightvale, a bustling city with tall buildings, parks,
and a shining sun. Suddenly, a dark shadow creeps over the skyline, dimming the light.
People look up, confused.
  **Dialogue:**
  - Narrator: “Brightvale was a happy city until the day the sun started to fade...”
  - Citizen 1: “Why is it getting dark?”
  - Citizen 2: “Something's wrong!”
  **Description:** The colors shift from bright yellows to grays. Captain Blaze
(red cape, fiery hair) and Luna Star (silver suit, glowing hands) fly into view, hovering
above the city.
  **Emotion:** Captain Blaze looks worried; Luna Star is determined.
  #### Page 2: Meet the Heroes
  **Scene:** A two-panel page. First panel: Captain Blaze lands on a rooftop, fists
clenched. Second panel: Luna Star joins him, scanning the horizon.
  **Dialogue:**
  - Captain Blaze: “I don't know if I can fix this, Luna. What if I mess up?”
  - Luna Star: “We're a team, Blaze. You've got the heart of a hero-trust it!”
  **Description:** Blaze's face shows doubt, his cape fluttering. Luna's glowing
hands light up the panel, her expression calm and encouraging. The rooftop has cracked
tiles and a blinking radio tower.
  **Emotion:** Blaze's nervousness contrasts with Luna's confidence.
  #### Page 3: The Secret Lair
  **Scene:** Inside the Sky Guardians' hideout-a high-tech room under a school
gym with glowing screens and a big map of Brightvale.
  **Dialogue:**
  - Luna Star: “The shadow's coming from the old windmill outside town.”
  - Captain Blaze: “That place gives me the creeps, but we have to check it out!”
  **Description:** The lair has gadgets (a hoverboard, energy gloves), a basketball
hoop (hinting at the school), and a window showing the dim sky. Blaze scratches his
head, unsure.
  **Emotion:** Suspense builds as they plan their mission.
  #### Page 4-5: The Central Conflict - The Shadow Machine
  **Scene:** A full-page spread (Page 4) of the creepy windmill-rusted, tilted,
with black smoke pouring out. Page 5: Three panels-Blaze and Luna sneak inside, find
a giant machine spitting shadows, and spot a lost bird trapped in its gears.
  **Dialogue:**
  - Blaze: “Look! That bird's stuck-it must've turned this thing on!”
  - Luna: “We need to shut it down, but it's too strong for me alone.”
  **Description:** The windmill's interior is dark, with cobwebs and spinning
blades. The machine glows purple, casting eerie shadows. The bird chirps weakly.
  **Emotion:** Tension rises; Blaze's eyes widen at the challenge.
  #### Page 6-7: Captain Blaze's Big Moment
  **Scene:** Page 6: Blaze hesitates, staring at the machine. Page 7: He flies up,
dodging gears, and uses his fire to melt a key part, freeing the bird.
  **Dialogue:**
  - Blaze (thinking): “I'm scared, but Luna believes in me. I can do this!”
  - Luna: “Blaze, you're amazing! Keep going!”
  **Description:** Page 6 shows Blaze's clenched fists and sweaty brow in a close-
up. Page 7 has dynamic action-flames burst, gears grind, and the bird flaps free.
  **Emotion:** Suspense turns to triumph; Blaze grows braver.
  #### Page 8-9: Teamwork Saves the Day
  **Scene:** Page 8: Luna uses her strength to lift the broken machine. Page 9:
Together, they carry it outside as the sun brightens.
  **Dialogue:**
  - Luna: “One last push, Blaze-together!”
  - Blaze: “We did it! The light's back!”
  **Description:** Page 8: Luna grunts, muscles flexing, while Blaze steadies her
with fire jets. Page 9: A wide shot of the windmill, sun shining, bird flying away.
  **Emotion:** Joy and relief; teamwork shines.
  #### Page 10: The City Cheers
  **Scene:** Back in Brightvale, kids and adults clap as Blaze and Luna land in the
park.
  **Dialogue:**
  - Kid: “You're the best, Sky Guardians!”
  - Blaze: “I was scared, but helping others made me strong.”
  **Description:** The park has swings, a fountain, and a bright blue sky. Blaze
smiles shyly; Luna gives a thumbs-up.
  **Emotion:** Pride and happiness.
  #### Page 11: Reflection in the Lair
  **Scene:** Back in the hideout, Blaze and Luna high-five, the bird perched
nearby.
  **Dialogue:**
  - Luna: “You didn't give up, Blaze. That's real hero stuff.”
  - Blaze: “Yeah, I guess I'm braver than I thought!”
  **Description:** The room glows warmly, with the map showing a sunny
Brightvale.
  **Emotion:** Contentment and growth.
  #### Page 12: The End - A New Day
  **Scene:** A full-page shot of Blaze and Luna soaring over Brightvale, the sun
shining bright.
  **Dialogue:**
  - Narrator: “The Sky Guardians learned that courage and teamwork can light up
any darkness!”
  **Description:** The city sparkles below, with green parks and gleaming towers.
The heroes' capes wave proudly.
  **Emotion:** Hope and excitement.
  ---
  ### Quality Control Checklist:
  **Aligned with RL.4.3**: Focuses on Captain Blaze's in-depth development-
his thoughts (self-doubt), feelings (fear, pride), and actions (saving the bird).
  **Superhero Interest**: Features original heroes with Superman-like flight and
Wonder Woman-like strength, emphasizing justice and compassion.
  **No Inappropriate Content**: Clean, positive story with no violence beyond
mild action (melting gears).
  **Positive Values**: Courage, teamwork, and helping others are central.
  **Clear Plot Arc**: Beginning (shadow appears), middle (machine conflict), end
(sun restored).
  **Age-Appropriate**: Simple vocabulary (e.g., “creeps,” “amazing”) and school-
friendly setting.
  **Educational Value**: Encourages describing characters and events with detail.
  ---
  ### Alignment with RL.4.3:
  This story aligns with RL.4.3 by focusing on Captain Blaze's character arc, using
specific details-like his hesitant thoughts on Page 6 and bold actions on Page 7-to
show how he grows from doubt to confidence. The detailed setting (Brightvale, the
windmill) and key event (freeing the bird) give 4th graders plenty to analyze, meeting the
standard's depth requirement.
```

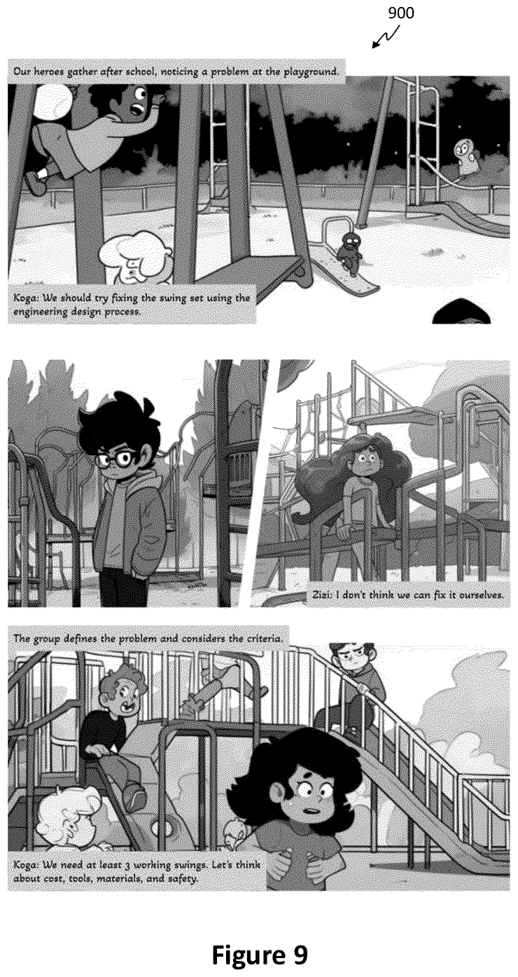

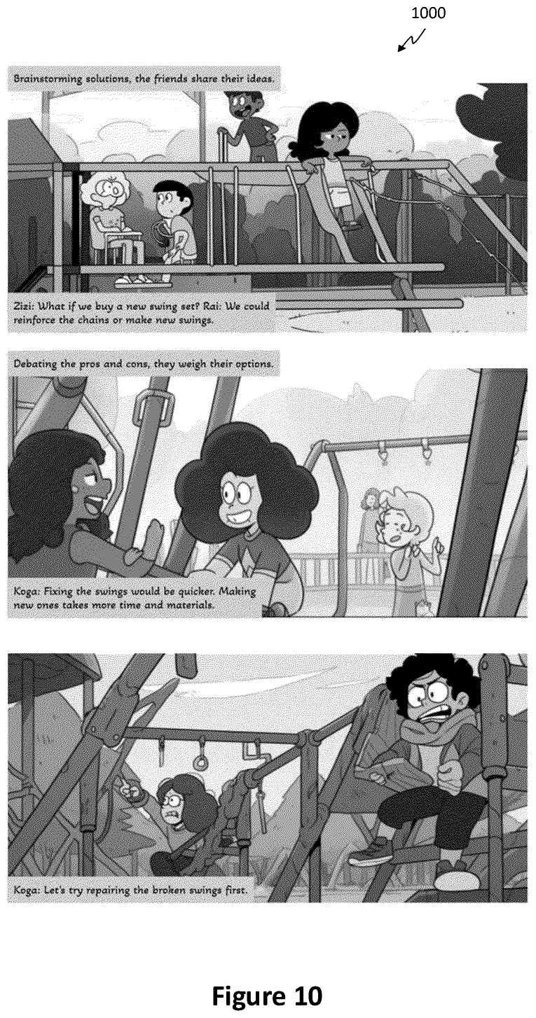

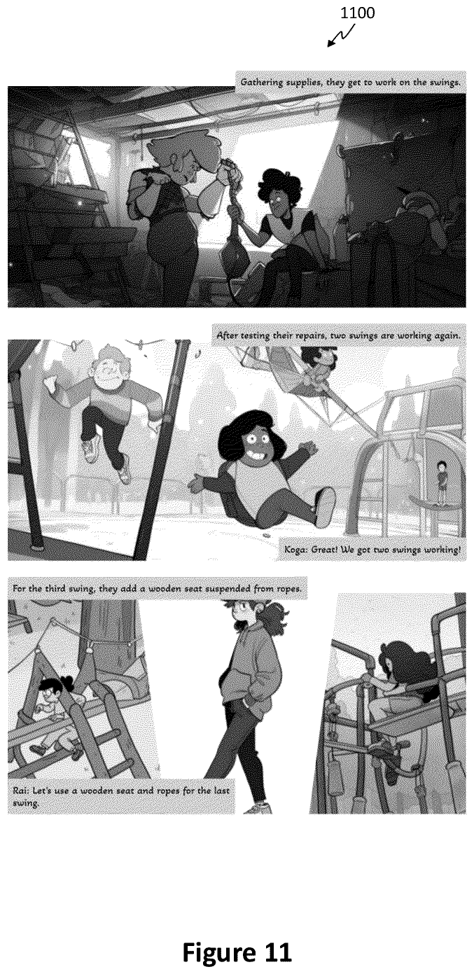

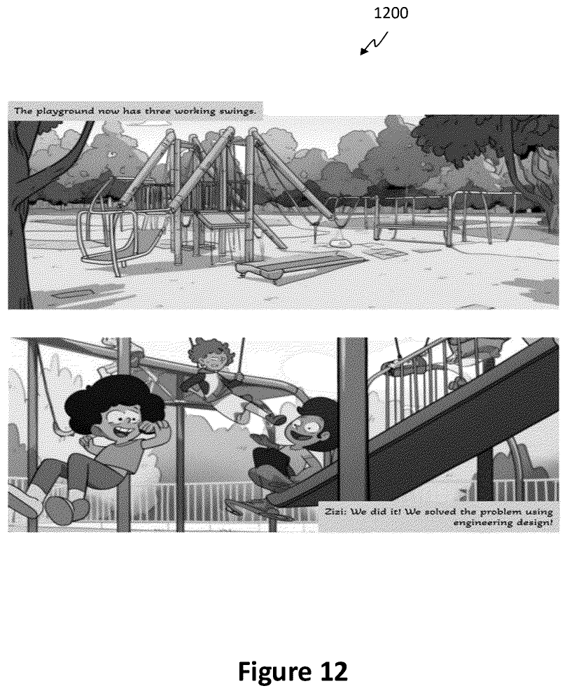

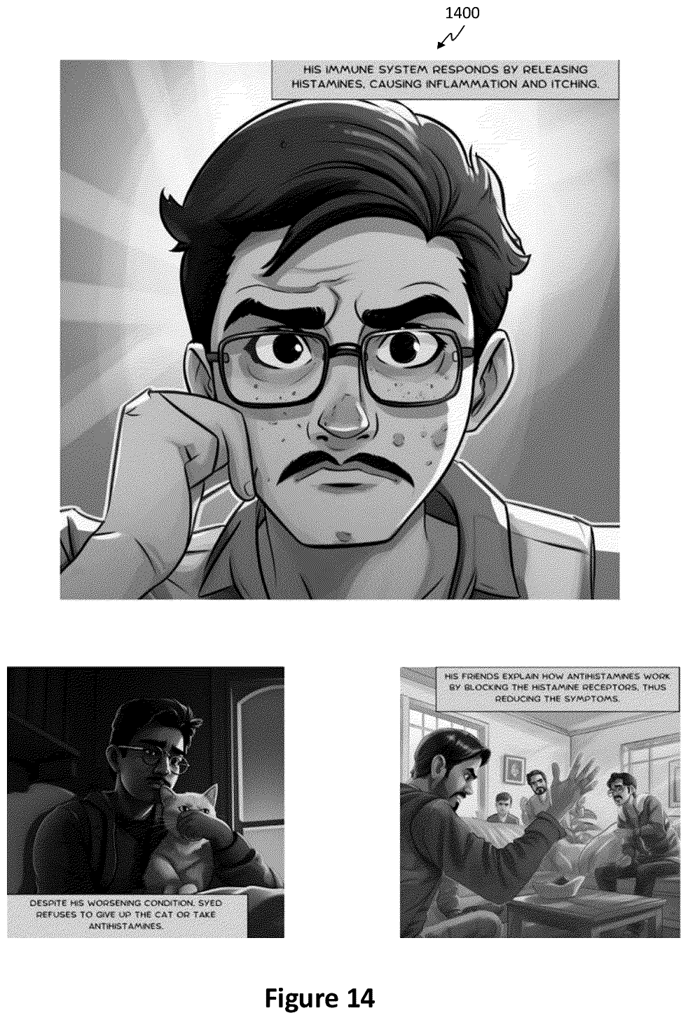

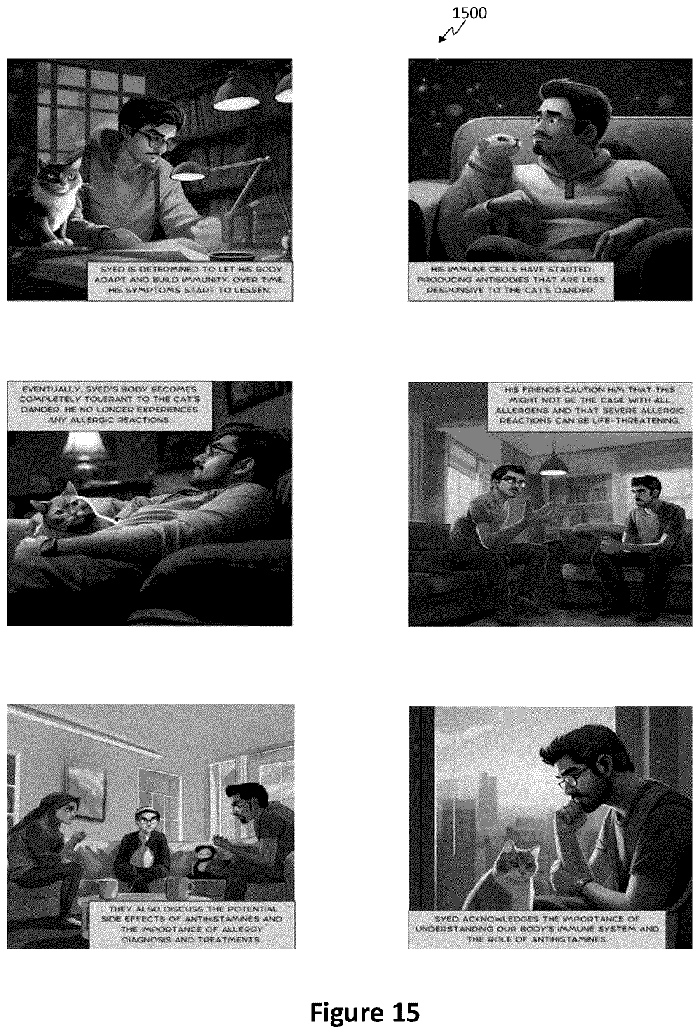

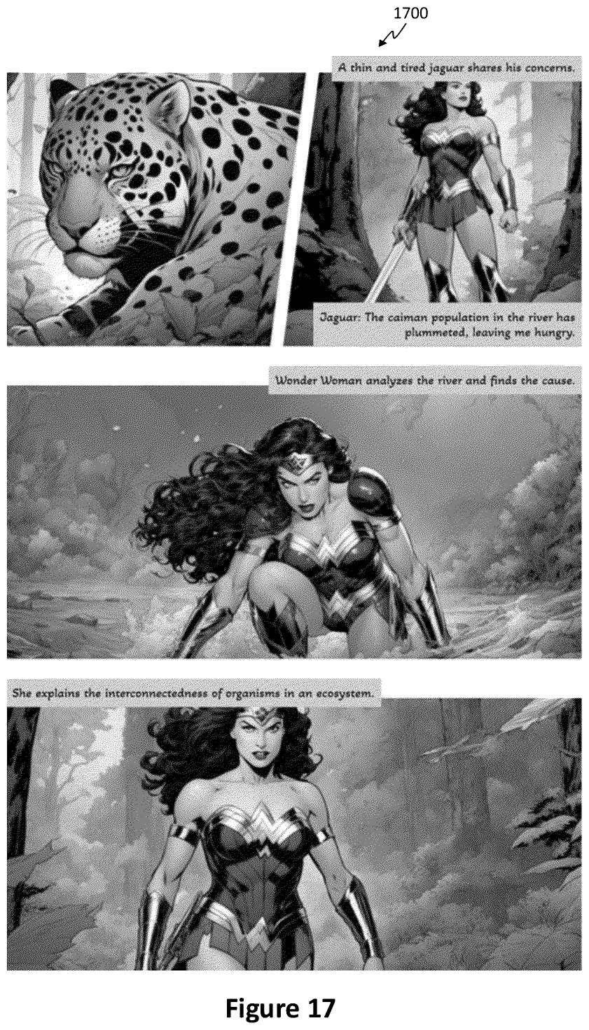

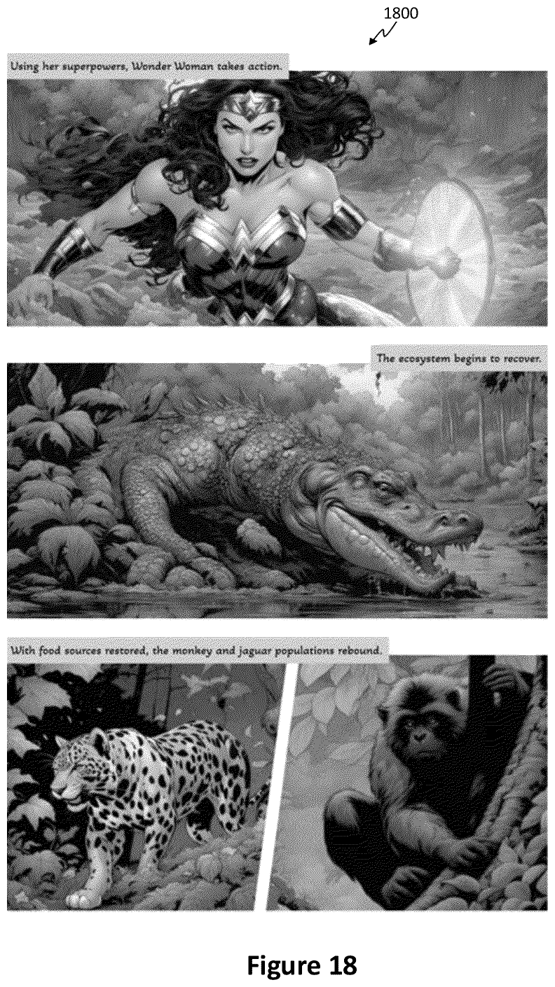

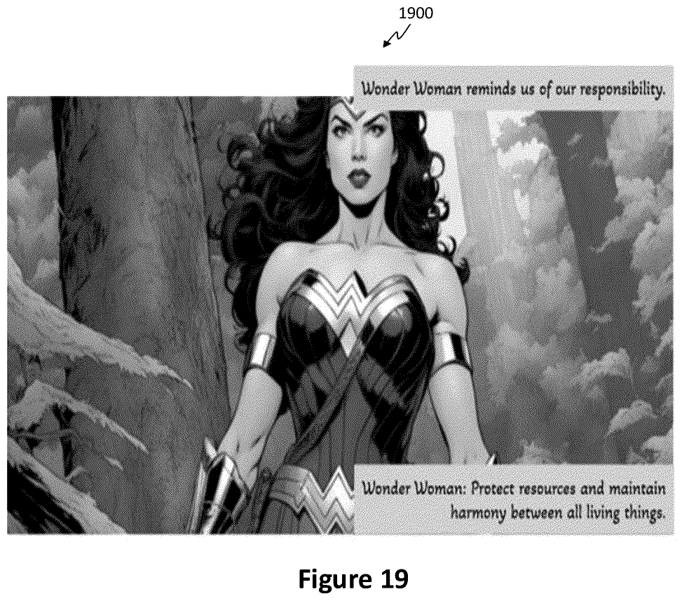

FIG. 9-19 depicts an exemplary view 900 of the dynamically generated personalized comic based on the user's interest, proficiency and educational curriculum. In FIG. 9-19, the exemplary view of the comic 900 generated is shown. The comic 900 is generated using comic generator 124 which incorporates artificial intelligence tools like ChatGPT4, Claude 2, Midjourney, SDXL and so on in it. Although besides these artificial intelligence tools various other machine learning models, NLP's, LLM (large language model) can also be used. For this purpose, the blueprint generator 126, panel generator 128, text generator 130 and text-to-image diffusion mode 132 is used. The function of these components is explained in detail with respect to FIG. 1 and FIG. 2.

The comic 900 is generated based on the student's pre-stored personal details 114, one or more student's interest 108, educational curriculum 116 and student's proficiency. The student's pre-stored personal details 114 is retrieved from the student profile 112 where the personal details of the student are stored like name, age, class, hobbies, friend's details, family details, favorite cartoon and so on. The one or more student's interests 108 are also retrieved from the interaction between student and chatbot 106, where the student enters the details asked by the chatbot 106 like ‘which projects are you working on?’, ‘did you visited any place at the latest?’, ‘share any daily life event of yours’ and so on. The student interacts with the chatbot 106 through a computing device, which may include computer, mobile, tablet etc., i.e., a device which is operatively coupled to the comic generation platform 102. Also, based on the quiz conducted in the starting of the session and during the chatbot discussion as well, the proficiency of the student is defined. Further, the one or more educational standards 116 are collected from one or more official standards like Common Core, AP, NGSS and so on. A curriculum graph 118 is generated based on curriculum of one or more educational standards 116.

The data from chatbot 106 i.e., user interest's 108, data from user profile 112 i.e., user pre-stored personal details 114 and data from educational standards 116 i.e., curriculum graph 118 is stored and processed in comic topic identifier 122, where the best topic that suits the learning is chosen for the student using machine learning algorithms.

In case of the exemplary scenario disclosed here, the input details provided to the comic generator 124 includes:

```
  Topic: NGSS - 3-5-ETS1-2
    Interests:
    Type: Fiction
    Value: Koga
    Teaching Scope:
    (Fetched from the Curriculum graph using Topic.)
    Subject: Science
    Domain: Engineering, Technology, and Applications of Science
    Cluster: Engineering Design
    Standard (this is the learning objective): Generate and compare
multiple possible solutions to a problem based on how well each is
likely to meet the criteria and constraints of the problem.
    Grade level: 5
```

The output of this is the comic generated 900, which is a science fiction comic of Grade 5, teaches the student about the problem-solving methods using engineering design technology. The character used in the comic is a Koga cartoon.

The personalized comic engages the student as the student gets a chance to learn from their favorite comic character. The students also have options to change the character if the student doesn't like the comic. The student may even interact using a chatbot 106 and give instructions like ‘change cartoon character to Pokemon and so on. Based on this a new comic with the same subject, topic and intent but with different characters and content will be generated automatically using the comic generator 124.

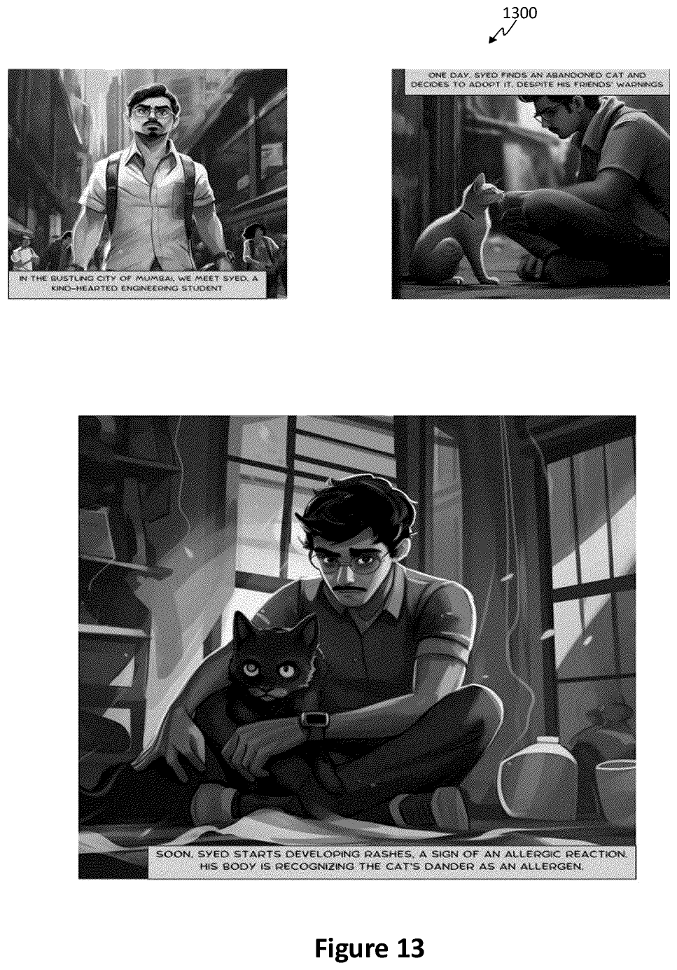

In another example shown in FIGS. 13-15, the input provided by the user to generate a personalized comic is the prompt to create a character that looks similar to the user.

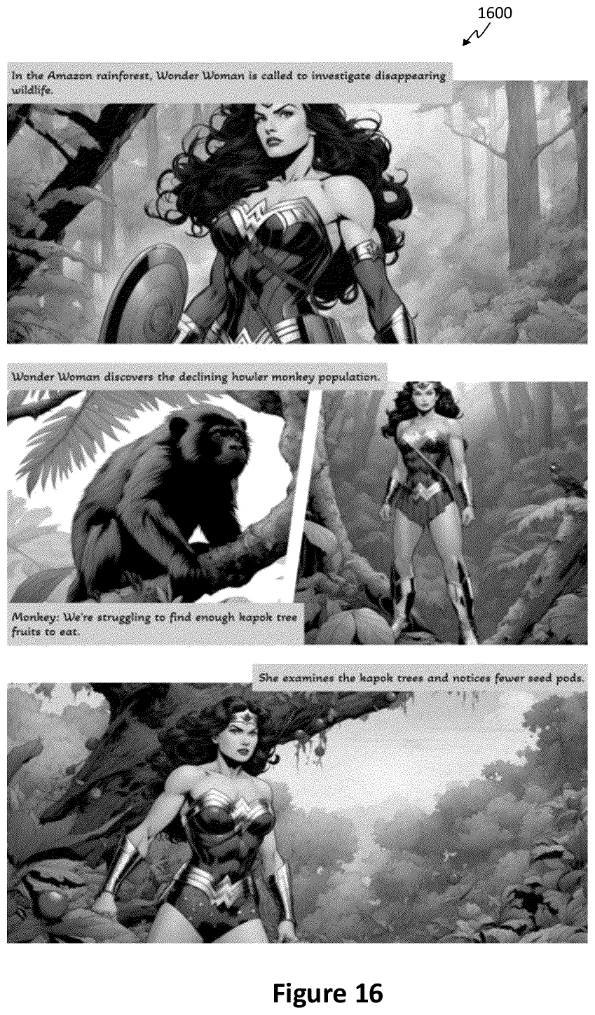

In yet another example shown in FIGS. 16-19, the input provided by the user to generate a personalized comic includes:

```
  Topic: NGSS - MS-LS2-1
  Interests:
  Type: Fiction
  Value: Wonder Woman
  Teaching Scope:
  (Fetched from the Curriculum graph using Topic.)
  Subject: Science
  Domain: Life Science
  Cluster: Ecosystems: Interactions, Energy, and Dynamics
  Standard (this is the learning objective): Analyze and interpret
data to provide evidence for the effects of resource availability on
organisms and populations of organisms in an ecosystem.
  Grade level: 6
```

Based on the foregoing, the generated comic includes a story pertaining to the life science domain, where the main character is a wonder woman, which correlates to the user's interest in the user's profile of superheroes and particularly women superheroes.

In an embodiment, a comic generation environment 100 for dynamically updating user profiles 112 to enhance comic generation in real time includes monitoring user interactions, interests and engagement metrics during the comic generation. The user profile 112 is updated based on the observed behavior and feedback, including change in interests, comprehension levels and learning preferences. The revised comic content is generated by utilizing the updated user profile 112, even when the user requests the generation of the same comic after some amount of time. This enhances the user engagement and personalizes the learning experience with each iteration.

In another embodiment, the method 200 of generating personalized comic content in which the user interests of multiple users are received which includes the same topics, same characters, same storyline and same interests. The one or more AI tool is utilized to dynamically generate comic content for each user based on the unique interests of the user, learning styles and chatbot interactions. The distinct comic narratives and visuals are generated for each user, even when the input is identical.

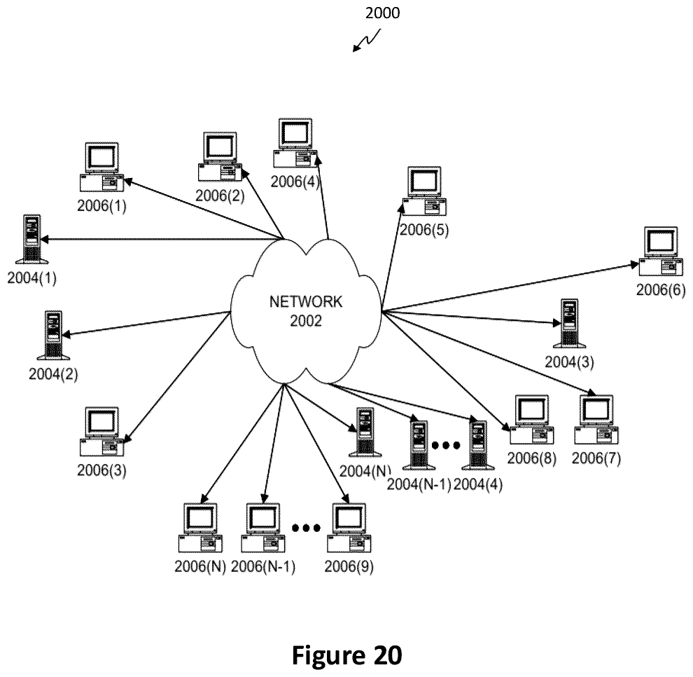

FIG. 20 is a block diagram illustrating a network environment in which the comic generation environment 2000 and method 2100 may be practiced. Network 2002 (e.g. a private wide area network (WAN) or the Internet) includes a number of networked server computer systems 2004(1)-(N) that are accessible by client computer systems 2006(1)-(N), where N is the number of server computer systems connected to the network. Communication between client computer systems 2006(1)-(N) and server computer systems 2004(1)-(N) typically occurs over a network, such as a public switched telephone network over asynchronous digital subscriber line (ADSL) telephone lines or high-bandwidth trunks, for example communications channels providing TI or OC3 service. Client computer systems 2006(1)-(N) typically access server computer systems 2004(1)-(N) through a service provider, such as an internet service provider (“ISP”) by executing application specific software, commonly referred to as a browser, on one of client computer systems 2006(1)-(N).

Client computer systems 2006(1)-(N) and/or server computer systems 2004(1)-(N) are specialized computer programmed to improve conventional computer systems to implement and utilize the comic generation environment 2000 and method 2100. The type of computer system that can be specially programmed to implement and utilize the comic generation environment 2000 and method 2100 include a mainframe, a mini-computer, a personal computer system including notebook computers, a wireless, mobile computing device (including personal digital assistants, smart phones, and tablet computers). These computer systems are typically designed to provide computing power to one or more users, either locally or remotely. Each computer system may also include one or a plurality of input/output (“I/O”) devices coupled to the system processor to perform specialized functions. Tangible, non-transitory memories (also referred to as “storage devices”) such as hard disks, compact disk (“CD”) drives, digital versatile disk (“DVD”) drives, and magneto-optical drives may also be provided, either as an integrated or peripheral device. In at least one embodiment, the comic generation environment 2000 and method 2100 can be implemented using code stored in a tangible, non-transient computer readable medium and executed by one or more processors. In at least one embodiment, the comic generation environment 2000 and method 2100 can be implemented completely in hardware using, for example, logic circuits and other circuits including field programmable gate arrays.

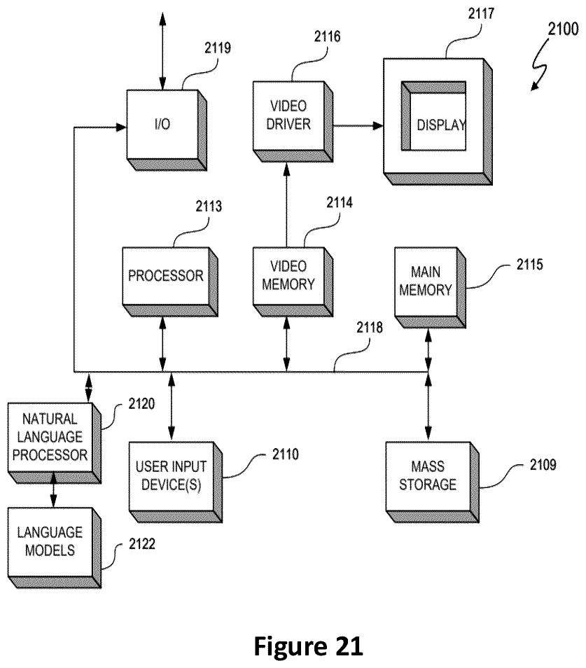

Embodiments of the comic generation environment 2000 and method 2100 can be implemented on a computer system such as a special-purpose, special-programmed computer 2100 illustrated in FIG. 21. Input user device(s) 2110, such as a keyboard and/or mouse, are coupled to a bi-directional system bus 2118. The input user device(s) 2110 are for introducing user input to the computer system and communicating that user input to processor 2113. The computer system of FIG. 21 generally also includes a non-transitory video memory 2114, non-transitory main memory 2115, and non-transitory mass storage 2109, all coupled to bi-directional system bus 2118 along with input user device(s) 2110 and processor 2113. The mass storage 2109 may include both fixed and removable media, such as a hard drive, one or more CDs or DVDs, solid state memory including flash memory, and other available mass storage technology. Bus 2118 may contain, for example, 32 of 64 address lines for addressing video memory 2114 or main memory 2115. The system bus 2118 also includes, for example, an n-bit data bus for transferring DATA between and among the components, such as CPU 2109, main memory 2115, video memory 2114 and mass storage 2109, where “n” is, for example, 32 or 64. Alternatively, multiplex data/address lines may be used instead of separate data and address lines.

I/O device(s) 2119 may provide connections to peripheral devices, such as a printer, and may also provide a direct connection to a remote server computer system via a telephone link or to the Internet via an ISP. I/O device(s) 2119 may also include a network interface device to provide a direct connection to a remote server computer system via a direct network link to the Internet via a POP (point of presence). Such connection may be made using, for example, wireless techniques, including digital cellular telephone connection, Cellular Digital Packet Data (CDPD) connection, digital satellite data connection or the like. Examples of I/O devices include modems, sound and video devices, and specialized communication devices such as the aforementioned network interface.

Computer programs and data are generally stored as code in a non-transient computer readable medium such as a flash memory, optical memory, magnetic memory, compact disks, digital versatile disks, and any other type of memory. The computer program is loaded from a memory, such as mass storage 2109, into main memory 2115 for execution. Computer programs may also be in the form of electronic signals modulated in accordance with the computer program and data communication technology when transferred via a network. In at least one embodiment, Java applets or any other technology is used with web pages to allow a user of a web browser to make and submit selections and allow a client computer system to capture the user selection and submit the selection data to a server computer system.

The processor 2113, in one embodiment, is a microprocessor manufactured by Motorola Inc. of Illinois, Intel Corporation of California, or Advanced Micro Devices of California. However, any other suitable single or multiple microprocessors or microcomputers may be utilized. Main memory 2115 is comprised of dynamic random-access memory (DRAM). Video memory 2114 is a dual-ported video random access memory. One port of the video memory 2114 is coupled to the video amplifier 2116. The video amplifier 2116 is used to drive the display 2117. Video amplifier 2116 is well known in the art and may be implemented by any suitable means. This circuitry converts pixel DATA stored in video memory 2114 to a raster signal suitable for use by display 2117. Display 2117 is a type of monitor suitable for displaying graphic images.

The computer system described above is for purposes of example only. The comic generation environment 2000 and method 2100 may be implemented in any type of computer system or programming or processing environment. It is contemplated that the comic generation environment 2000 and method 2100 might be run on a stand-alone computer system, such as the one described above. The comic generation environment 2000 and method 2100 might also be run from a server computer systems system that can be accessed by a plurality of client computer systems interconnected over an intranet network. Finally, the comic generation environment 2000 and method 2100 may be run from a server computer system that is accessible to clients over the Internet.

Although embodiments have been described in detail, it should be understood that various changes, substitutions, and alterations can be made hereto without departing from the spirit and scope of the invention as defined by the appended claims.

What is claimed is:

1. A method performed by an integrated programmatic system and an AI system, the method comprising:
performing by the programmatic system:
receiving a selected learning topic for a comic generation;
receiving a selected educational standard;
generating a prompt, wherein the prompt includes an educational standard and data representing the selected learning topic; and
submitting the prompt to the AI system, wherein the prompt guides and constrains the AI system to generate the comic to have a topic aligned with the selected learning topic and educational standard;
receiving from the AI system a comic that aligns with the educational standard and the data representing the selected learning topic, wherein the comic includes multiple scenes and dialogue in the scenes; and
distributing the comic.

2. The method of claim 1 further comprising:
selecting a learning topic for a comic generation, wherein selecting the learning topic comprises:
accessing a user profile via a comic generation platform;
accessing one or more curriculum graphs stored in a curriculum database; and
generating one or more learning topics relevant to the user profile and the one or more curriculum graphs;
identifying one or more user profile details that matches the selected learning topic, wherein identifying the one or more user profile details comprises:
retrieving the one or more user profile details from the user profile;
comparing the one or more user profile details with the selected topic; and
prompting an Artificial Intelligence tool to pick matching one or more user profile details that best suits the learning topic; and
automatically generating a comic based upon the identified one or more user profile details, wherein automatically generating the comic comprises:
creating a comic blueprint including at least a storyline and one or more characters, wherein the storyline and characters are inspired from the names and incidents shared in the user profile details;
creating one or more comic panels, wherein each panel includes a scene having a background and the one or more characters;
generating dialogues for each panel; and
combining the dialogues to the corresponding scenes to generate a personalized comic.

3. The method of claim 1 wherein the educational standard is implemented as one or more curriculum graphs, the method further comprising:
generating one or more curriculum graphs stored in a curriculum database, wherein
generating the one or more curriculum graphs further comprises:
accessing one or more educational standards from official sources; and
organizing one or more educational standard into a graph database, wherein each topic is represented as a node and prerequisite relationships between the nodes are represented as edges.

4. The method of claim 3 wherein the official sources include Common Core State Standards (CCSS), NGSS (Next Generation Science Standards) and AP.

5. The method of claim 1 wherein the user profile details comprises:
one or more pre-stored personal details of the user stored within a memory of the comic generator platform; and
one or more user interests identified based on the user's interaction with a chatbot, wherein the chatbot is presented via a user interface of the comic generator device when the user logs into the comic generator platform.

6. The method of claim 1 further comprising:
selecting the learning topic, and selecting the learning topic comprises at least one of:
automatically selecting the learning topic based upon one or more pre-stored personal details of the user and user interests identified based on the user's interaction with a chatbot using a machine learning algorithm; and
manually inputting the learning topic while interacting with a chatbot.

7. The method of claim 1 further comprising:
creating one or more comic panels, wherein creating one or more comic panels comprises:
employing a text-to-image stable diffusion model in order to generate a cohesive panel with consistent backgrounds and consistent characters across the corresponding panels.

8. The method of claim 1 wherein the comics are created based on the one or more educational standard relevance by incorporating curriculum graphs to visualize learning pathways and match them with user's interests and proficiency to enhance comprehension and engagement.

9. The method of claim 1 wherein the generated comic is displayed to the user via a user interface on the comic generation platform.

10. The method of claim 1 further comprises:
monitoring user engagement with the comic content on a real-time basis;
analyzing user interaction data based upon user's interaction through the chatbot to assess comprehension and interest level; and
utilizing the analyzed data to dynamically adjust the comic content on a real-time basis, ensuring alignment with the evolving needs and preferences of the user.

11. The method of claim 1 further comprises:
generating unique comic narratives and visuals for multiple users even when the selected learning topic is common, thereby ensuring personalization in each generated comic.

12. A system comprising:
one or more processors; and
a memory, coupled to the one or more processors, having code stored therein, wherein execution of the code causes an integrated programmatic system and AI system to perform operations comprising:
receiving a selected learning topic for a comic generation;
receiving a selected educational standard;
generating a prompt, wherein the prompt includes an educational standard and data representing the selected learning topic; and
submitting the prompt to the AI system, wherein the prompt guides and constrains the AI system to generate the comic to have a topic aligned with the selected learning topic and educational standard;
receiving from the AI system a comic that aligns with the educational standard and the data representing the selected learning topic, wherein the comic includes multiple scenes and dialogue in the scenes; and
distributing the comic.

13. The system of claim 12 comprising:
a comic generation platform including a user interface having a chatbot that allows communication between a user and the comic generation platform;
a comic topic identifier operatively coupled to the comic generation platform configured to:
collect user profile details including one or more pre-stored personal details of the user and one or more user interests identified based on user's interaction with the chatbot; and
identify a comic topic matching the user profile details and one or more curriculum graphs; and
identify one or more matching user profile details;
a comic generator to automatically generate a comic based upon the identified one or more user profile details comprising:
a blueprint generator to create comic blueprint which includes a story, one or more characters and one or more scenes in the comic;
a panel generator to create one or more comic panels, wherein each panel includes a scene having a background and the one or more characters;
a text generator to generate dialogues for each panel;
a text-to-image diffusor model to combine the dialogues to the corresponding scenes to generate the final comic.

14. The system of claim 13 wherein the comic topic identifier is further configured to:
retrieve the one or more user profile details stored in a memory of the comic generation 2 platform;
compare the one or more user profile details to the selected topic;
prompt an Artificial Intelligence (AI) tool to pick one or more matching profile details that best suits the selected comic topic, wherein the matching profile details are utilized to generate a personalized comic by the comic generator.

15. The system of claim 13 wherein the user interface further comprises:
a feedback loop mechanism to refine the generated panels based on the user feedback and chatbot interaction.

16. The system of claim 13 wherein the conic generator further includes one or more Artificial Intelligence tool comprising:
one or more Generative Pre-Trained Transformers specially trained for providing short and precise content on the basis of the prompt;
one or more specially trained for creative story-telling and comic generation.

17. The system of claim 13 uses the text-to-image diffusion model configured to generate the visual element of the comics, thereby creating engaging and relevant illustrations based on the text content.

18. The system of claim 13 further comprises determining user's reading level by taking a quiz generated once the user reads the generated comic, wherein the accuracy in attempting the quiz determines the complexity of the comics generated in future.

19. The system of claim 13 dynamically updates user profile to enhance comic generation in real-time, comprising:
monitoring user activities based on user inputs received via the chatbot and user engagement with the generated comic content on the comic generation platform;
updating the user profile based on the monitored activities and user feedback;
utilizing the updated user profile to generate revised comic content, wherein the system updates the content of the generated comic in real-time.

20. The system of claim 13 further comprises a feedback mechanism including options for qualitative feedback surveys, polls and comments, as well as quantitative feedback through analytics and performance metrics, thereby enabling continuous improvement in the content of generated comics.

21. The system of claim 13 wherein the generated personalized final comic includes or more pages and the comic is displayed to the user via the user interface of the comic generation platform.
